(19) United States
(12) Patent Application Publication
(10) Pub. No.: US 2014/0230695 A1
(43) Pub. Date: Aug. 21, 2014

(54) HYDRAULIC ENGINE MOUNT SOLUTION COMPOSITION

(71) Applicants: Kia Motors Corporation, Seoul (KR); Hyundai Motor Company, Seoul (KR)

(72) Inventors: Jong-Min Park, Incheon (KR); Kyung-Mo Yang, Suwon (KR); Chang-Kuk Im, Seoul (KR); Dae-Yun Bae, Yongin (KR); Sung-Uk Lee, Boryeung (KR)

(73) Assignees: KIA MOTORS CORPORATION, Seoul (KR); HYUNDAI MOTOR COMPANY, Seoul (KR)

(21) Appl. No.: 13/919,209

(22) Filed: Jun. 17, 2013

(30) Foreign Application Priority Data
Feb. 19, 2013 (KR) 10-2013-0017322

(51) Int. Cl. C09D 7/00

(52) U.S. Cl. CPC C09D 7/001
USPC 106/287.21; 106/287.26

(57) ABSTRACT

Disclosed is a hydraulic engine mount solution composition, and more specifically a hydraulic engine mount solution composition, which maintains vibration absorbing ability at high temperatures as well as at low temperatures due to its higher boiling point than conventional engine mount solutions, and which inhibits aging and extends life of the engine mount by inhibiting flowing out and cohesion of chemical additives from an anti-vibration rubber of the engine mount by inclusion of a dispersion stabilizer, thereby preventing blocking of a flow channel, such as orifice of the engine mount. In particular, the hydraulic engine mount solution composition comprises a solvent containing ethylene glycol and propylene glycol; a dispersion stabilizer; and a phenol-based antioxidant, a heat stabilizer, a metal corrosion inhibitor and the like.

### CROSS-REFERENCE TO RELATED APPLICATION

The present application claims priority of Korean Patent Application Number 10-2013-0017322 filed Feb. 19, 2013, the entire contents of which application is incorporated herein for all purposes by this reference.

### BACKGROUND

(a) Technical Field

The present invention relates to a hydraulic engine mount solution composition, and more specifically to a hydraulic engine mount solution composition which maintains vibration absorbing ability at high temperatures, and inhibits aging to extend life of the engine mount, particularly by inhibiting flowing out and cohesion of chemical additives from an anti-vibration rubber of the engine mount.

(b) Background Art

Vibration and noise are generated from engines of vehicles, such as automobiles and airplanes, due to various factors. Generally, periodical change of the center location of a piston and a connecting rod inside the engine by upward and downward movement, periodical change of inertial force and turning force applied to a crankshaft generated from alternating motion of a cylinder, and the like cause vibration and noise of the engine. Accordingly, in order to prevent and block the vibration and noise of the engine, an engine mount is disposed between the engine and an automobile frame.

More specifically, vibration generated by the engine affects an entire vehicle because the engine is not isolated within the vehicle body, but rather is connected to a transmission, an air conditioner and the like. Therefore, the engine is typically fixed to a car frame through the engine mount for damping the vibration generated by the engine. The engine mount is clamped between the engine and the car frame, and is typically formed of a rubber-type material that uses elasticity of the material and a hydraulic type material that damps the vibration by an inertial effect of liquid filled therein. The hydraulic engine mount is also called a hydro engine mount, and is widely used in a variety of car models because it is dampens the vibrations at both the higher frequency domains and the lower frequency domains.

Further, the hydraulic engine mount essentially contains an anti-vibration rubber and an engine mount solution, and, depending on the type of engine mount, also can contain a nozzle and an orifice as a fluid flowing channel.

The anti-vibration rubber, which contacts the engine mount solution, plays a role of shock-absorbing in the hydraulic engine mount, and it contains various chemical additives, such as an anti-aging agent for protecting the anti-vibration rubber from the external environment (e.g., ozone and heat). However, there is a problem with the anti-vibration rubber in that the vibration reducing ability of the engine mount is deteriorated by flowing out and cohesion of chemical additives of the anti-vibration rubber. These chemical additives then fuse to the orifice and the nozzle, thereby blocking the flow of the engine mount solution.

Further, in the past, in order to prevent deterioration of physical properties of the anti-vibration rubber of the engine mount at high temperatures, an engine mount solution prepared by mixing water and ethylene glycol at a weight ratio of 1:1, or a mixed solvent solution of ethylene glycol and propylene glycol has been used for increasing the boiling point of the engine mount solution.

However, the engine mount solution prepared by mixing water and ethylene glycol at a weight ratio of 1:1 has a low boiling point. Thus, there is a problem in that anti-vibration ability is sharply decreased by steam generated from the heated engine mount solution by increased temperature of the engine mount when running the engine for a long time or when running in bad road conditions.

Problems also occur in the case of the mixed solvent solution of ethylene glycol and propylene glycol. For example, Korean Patent No. 10-410335 describes an engine mount solution for an automobile, which uses a mixed solvent solution of ethylene glycol and propylene glycol for simply increasing boiling point of the mount solution, and an amine-based antioxidant. However, there were defects of rapid aging and deterioration of physical properties of the anti-vibration rubber, the elastic ball, the orifice and the like, which were in contact with the engine mount solution at high temperatures of 100° C. or more. Further, there was a problem of reduced fluidity of the engine mount solution which comprised materials generated from corrosion of the anti-vibration rubber, the elastic ball, the orifice and the like.

The description provided above as a related art of the present invention is just for helping understanding the background of the present invention and should not be construed as being included in the related art known by those skilled in the art.

### SUMMARY OF THE DISCLOSURE

The present invention provides a hydraulic engine mount solution composition, which has effects of: maintaining vibration absorbing ability at high temperatures as well as at low temperatures, and inhibiting aging and extending life of the engine mount. In particular, the hydraulic engine mount solution composition is capable of maintaining vibration absorbing ability due to the higher boiling point of the composition as compared to a conventional engine mount solution. Further, the hydraulic engine mount solution composition is capable of inhibiting aging and extending life of the engine mount, in particular, by inhibiting flowing out and cohesion of chemical additives from an anti-vibration rubber of the engine mount by a dispersion stabilizer.

According to one aspect, the hydraulic engine mount solution composition is characterized by comprising a mixed solution of ethylene glycol and propylene glycol as a solvent; a dispersion stabilizer; and a phenol-based antioxidant.

Further, it is preferred that the composition further comprises a heat stabilizer and a metal corrosion inhibitor, and the like. According to various embodiments, the composition comprises about 65˜70 wt % of ethylene glycol, about 25˜30 wt % of propylene glycol, about 2˜5 wt % of dispersion stabilizer and about 0.3˜7 wt % of phenol-based antioxidant, based on the total weight of the composition.

Preferably, the composition includes about 0.5˜3 wt % of the heat stabilizer and about 0.5˜5 wt % of the metal corrosion inhibitor, based on the total weight of the composition.

The dispersion stabilizer can be selected from any conventional dispersion stabilizers, and according to preferred embodiments, the dispersion stabilizer comprises at least one selected from the group consisting of: alkylphosphate, alkyletherphosphate and alkylaryletherphosphate.

is the phenol-based antioxidant can be selected from any conventional such antioxidants, and according to preferred embodiments, the phenol-based antioxidant comprises at least one selected from the group consisting of: 2,6-di-t-butyl-p-cresole, 4,4-thio-bis-(3-methyl-6-t-butylphenol), 4,4-butadiene-bis-(3-methyl-6-t-butylphenol) and 2,2-methylene-bis-(4-methyl-6-t-butylphenol). The heat stabilizer can be selected from any known heat stabilizers and, according to preferred embodiments, that the heat stabilizer is 2-mercaptobenzimidazole.

The metal corrosion inhibitor can be selected from any known metal corrosion inhibitors and, according to preferred embodiments, the metal corrosion inhibitor contains molybdate and benzotriazole, and the weight ratio of the molybdate and the benzotriazole is about 1:1˜1.5.

Preferably, the pH of the hydraulic engine mount composition is about 7˜9.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawing which is given hereinbelow by way of illustration only, and thus is not limitative of the present invention, and wherein:

FIG. 1 is a schematic diagram of a hydraulic engine mount according to an embodiment of the invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be described in detail with reference to the accompanying Tables and drawing.

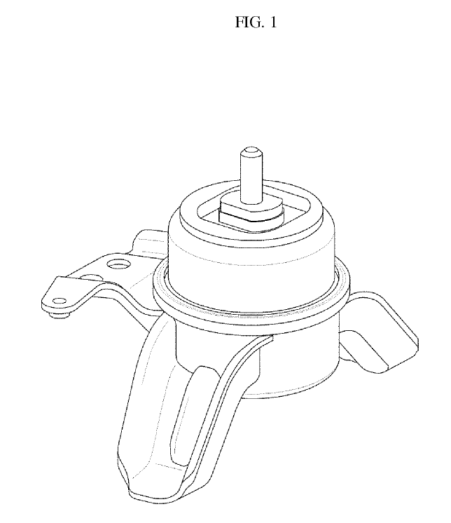

The engine mount is a part that supports an engine and fixes the engine to a vehicle body. Typically, the engine mount has an anti-vibration function for preventing transfer of engine vibration to the vehicle body. The engine mount may be a rubber engine mount made from a rubber, a hydraulic engine mount, which can largely dampen engine vibration by filling a liquid in the rubber, and the like. FIG. 1 is a schematic diagram of a hydraulic engine mount according to an embodiment of the invention. In general, and the hydraulic engine mount contains an anti-vibration rubber, an engine mount solution and the like. In particular, the present invention relates to a hydraulic engine mount solution composition comprising a mixed solvent of ethylene glycol and propylene glycol, a dispersion stabilizer and a phenol-based antioxidant. According to preferred embodiments, the hydraulic engine mount solution composition further comprises a heat stabilizer, a metal corrosion inhibitor and the like.

Hereinafter, components and contents of the present invention will be described in detail in connection with a preferred embodiment.

(1) Solvent

As a solvent applied the conventional hydraulic engine mounts, ethylene glycol is commonly used taking into consideration its influence on a rubber component. In particular, a mixture of the ethylene glycol and water is commonly used for maintaining an anti-vibration performance at a lower temperature, particularly at a weight ratio of 50 wt % ethylene glycol and 50 wt % water. However, with such conventional solvent compositions, there is a defect in that the anti-vibration performance of the engine mount is rapidly decreased by steam, which is easily generated due to the low boiling point of the solvent. In the present invention, instead of using water, propylene glycol, which is a colorless, odorless and non-toxic material, and plays a role of increasing the boiling point of the ethylene glycol, is used. Accordingly, the hydraulic engine mount solution composition according to the present invention uses a mixed solution of the ethylene glycol and the propylene glycol as a solvent.

Further, it is preferred that the composition contains ethylene glycol in an amount of about 65˜70 wt % and propylene glycol in an amount of about 25˜30 wt %, based on the total weight of the composition. When the amount of the ethylene glycol is less than about 65 wt %, the anti-vibration function of the engine may be decreased because the transfer of the solvent becomes difficult due to increased viscosity of the composition at lower temperatures, thereby narrowing the temperature range at which the composition may be used. When the amount of the ethylene glycol exceeds about 70 wt %, there may be a problem in that the anti-vibration ability of the engine is rapidly decreased by steam generated at high temperatures due to a lowered viscosity of the composition.

Likewise, when the amount of the propylene glycol is less than about 25 wt %, there may be a problem in that the anti-vibration ability of the engine is rapidly decreased by steam generated at high temperatures due to a lowered viscosity of the composition. When the amount of the propylene glycol exceeds about 30 wt %, the anti-vibration function of the engine may be decreased because the transfer of the solvent becomes difficult due to increased viscosity of the composition at lower temperatures.

(2) Dispersion Stabilizer

A main feature of the present invention is application of a dispersion stabilizer to the engine mount solution. The hydraulic engine mount essentially contains an anti-vibration rubber for absorbing the vibration, and an engine mount solution for increasing the anti-vibration effect. Depending to the type of the engine mount, the hydraulic engine mount may further contain a nozzle, an orifice and the like as a channel through which the engine mount solution flows. Rubbers, including the anti-vibration rubber, are easily degraded by ozone, heat, solvents and the like, and therefore, methods for inhibiting degradation using various chemical additives can be used for preventing the degradation.

However, the chemical additives often flow out of the surface of the anti-vibration rubber and are clumped. These clumped additives can block the nozzle, the orifice and the like, which serve as a fluid flow channel, and thereby block the flow of fluid. Accordingly, there is a problem of reducing the vibration reducing performance of the engine mount.

In order to prevent reduction of the anti-vibration ability of the engine mount caused by: flowing out of the chemical additives from the anti-vibration rubber, clumping thereof, and blocking of the flow channel, it is preferred that the engine mount solution contain a dispersion stabilizer.

The dispersion stabilizer may be any dispersion stabilizer known in the art, but it is preferred that it is selected from the group consisting of: alkylphosphate, alkyletherphosphate, alkylaryletherphosphate and the like, and combinations thereof. Most preferably, the dispersion stabilizer contains alkylphosphate.

Further, it is preferred that the dispersion stabilizer is added in an amount of about 2˜5 wt %, more preferably about 2˜4 wt %, based on the total weight of the composition. When the amount thereof is less than about 2 wt %, sufficient dispersion stability and the effect of inhibiting cohesion of the chemical additives are not obtained. When the amount exceeds about 5 wt %, there may be a problem caused by reduction of other components, and economical efficiency may be decreased by saturation of the effect (i.e., further benefits are not obtained by providing amounts in excess of about 5 wt %).

(3) Phenol-Based Antioxidant

Similar to degradation of the anti-vibration rubber or the elastic ball by oxygen, when oxygen dissolved in the engine mount solution and the like penetrates into the anti-vibration rubber or an elastic ball of the engine mount, the rubber can be easily oxidized. Accordingly, an antioxidant should be added to the composition during a synthesis process, during storage or during use of the composition for preventing oxidation. In particular, it was found that the aging of rubber is caused by oxygen absorption, and also it was confirmed that a phenol-based compound can delay or prevent the oxidation.

Accordingly, it is preferred that the present composition contain an antioxidant. Any antioxidant known in the art can be used, such as a phenol-based antioxidant, an aromatic amine-based antioxidant, a phosphite-based antioxidant and a sulfur ester-based antioxidant. Preferably, the antioxidant is a phenol-based antioxidant, and more preferably the antioxidant includes at least one selected from the group consisting of 2,6-di-t-butyl-p-cresol, 4,4-thiobis-(3-methyl-6-t-butylphenol), 4,4-butadiene-bis-(3-methyl-6-t-butylphenol), 2,2-methylene-bis-(4-methyl-6-t-butylphenol) and the like.

It is preferred that the amount of the phenol-based antioxidant is about 0.3˜7 wt %, more preferably about 0.5˜5 wt %, based on the total weight of the composition. When the amount of the antioxidant is less than about 0.3 wt %, the deterioration of physical properties of the anti-vibration rubber, the elastic ball and the like may be severe because it becomes difficult to inhibit the degradation of the anti-vibration rubber, the elastic ball and the like. When the amount of the antioxidant exceeds about 7 wt %, there may be a problem of unnecessarily increased costs due to saturation of the oxidation preventing effect in amounts in excess of about 7 wt %.

(4) Heat Stabilizer

It is preferred that the present composition contains a heat stabilizer to inhibit viscosity change of the composition according to temperature change. The heat stabilizer may be any known in the art. Preferably, the heat stabilizer is 2-mercaptobenzimidazole.

Further, it is preferred that the amount of the heat stabilizer is about 0.5˜3 wt %, based on the total weight of the composition. When the amount of the heat stabilizer is less than about 0.5 wt %, the viscosity change of the composition according to the temperature change may become large. When the amount of the heat stabilizer exceeds about 3 wt %, there may be problems in that the flow of the composition may be inhibited by precipitation of the heat stabilizer caused by the use of an excessive amount of the heat stabilizer, and the cost may increase by saturated effect (i.e. further benefits may not be provided by use of amounts in excess of about 3 wt %).

(5) Metal Corrosion Inhibitor

It is preferred that the present composition contains a metal corrosion inhibitor for preventing corrosion of the metal structure constituting the hydraulic engine mount, such as the orifice. The metal corrosion inhibitor may be any known in the art. Preferably, the metal corrosion inhibitor is molybdate and/or benzotriazole.

Further, it is preferred that the amount of the metal corrosion inhibitor is about 0.5˜5 wt %, based on the total weight of the composition. When the amount of the metal corrosion inhibitor is less than about 0.5 wt %, the metal corrosion inhibiting effect may decrease, and when it exceeds about 5 wt %, fluidity of the composition may be disrupted.

Further, when using a mixture of the molybdate and the benzotriazole as the metal corrosion inhibitor, the weight ratio of the molybdate and the benzotriazole is preferably about 1:1˜1.5, and more preferably about 1:1.2˜1.4.

Herein, when the weight ratio of the benzotriazole is less than about 1, the metal structure may be corroded, and when it exceeds about 1.5, the production cost of the composition may unnecessarily increase by the saturated metal corrosion inhibiting effect (i.e. further benefits may not be obtained as the amount exceeds 1.5).

(6) Composition pH

The pH of the hydraulic engine mount solution according to the present invention is preferably about 7˜9, and particularly when mixing the composition, the pH is preferably about 7˜9.

Further, when pH of the engine mount solution is less than about 7, the corrosion of the metal structure of the engine mount may be accelerated, and when it exceeds about 9, there may be floating matters in the composition.

(7) Amine-Based Antioxidant

The present invention may contain an amine-based antioxidant, which helps the phenol-based antioxidant in inhibiting the oxidation of the metal structure constituting the engine mount. The amine-based antioxidant may be any amine-based antioxidant known in the art, but it is preferably triethanolamine.

(8) Anti-Corrosion Agent

The present composition preferably further contains an anti-corrosion agent for inhibiting the corrosion of the metal structure constituting the engine mount. The anti-corrosion agent may be any anti-corrosion agent known in the art, but it is preferably sodium benzoate.

(9) Use

It is preferred that the hydraulic engine mount solution according to the present invention is applied to hydraulic engine mounts for vehicles such as a ship, a locomotive, a motorcycle and the like. More preferably, the present composition is applied to a hydraulic engine mount for an automobile.

(10) Manufacturing Method

The hydraulic engine mount solution composition according to the present invention can be properly manufactured by a person skilled in the art referring to known methods. Specifically, it may contain the solvent which comprises ethylene glycol and propylene glycol, the solvent, the dispersion stabilizer and the various chemical additives, as well as the phenol-based antioxidant. According to preferred embodiments, the composition is manufactured by combining about 65˜70 wt % of ethylene glycol, about 25˜30 wt % of propylene glycol, about 2˜5 wt % of dispersion stabilizer, about 0.3˜7.0 wt % of phenol-based antioxidant and the like. Such a composition provides the constitutional characteristics mentioned above.

Hereinafter, the present invention will be described in further detail with reference to examples. It will be obvious to a person having ordinary skill in the art that these examples are for illustrative purposes only and are not to be construed to limit the scope of the present invention.

### EXAMPLES

In Examples 1 to 3, which are in accordance with the present invention, hydraulic engine mount solutions having the compositions listed in the following Table 1 were manufactured while checking pH using a pH meter at room temperature to maintain pH 7.5˜8 by using a solution and dissolving a certain amount of sodium hydroxide in a small amount of water.

Further, in the Comparative Example, a hydraulic engine mount solution having the composition listed in the following Table 1 was manufactured according to the same method as the above Examples 1 to 3. In contrast with Examples 1 to 3, Comparative Example 1 did not contain a dispersion stabilizer.

TABLE 1

| | | | | | | Comp. |
|---|---|---|---|---|---|---|
| Section | | Unit | Exam. 1 | Exam. 2 | Exam. 3 | Exam. 1 |
| Solvent | Ethylene glycol | wt % | 65 | 64 | 56 | 66 |
| | Propylene glycol | wt % | 26 | 26 | 26 | 26 |
| Phenol-based | 4,4-thio-bis-(3- | wt % | 2 | 2 | 2 | 2 |
| antioxidant | methyl-6-t- | | | | | |
| | butylphenol) | | | | | |
| Amine-based | Triethanolamine | wt % | 1.0 | 1.0 | 1.0 | 1.0 |
| antioxidant | | | | | | |
| Heat stabilizer | 2-Mercaptobenzimidazole | wt % | 2.0 | 2.0 | 2 | 2 |
| Metal corrosion | Molybdate | wt % | 1.0 | 1.0 | 1.0 | 1.0 |
| inhibitor | Benzotriazole | wt % | 1.5 | 1.5 | 1.5 | 1.5 |
| Anti-corrosion | Sodium Benzoate | wt % | 0.5 | 0.5 | 0.5 | 0.5 |
| Agent | | | | | | |
| Dispersion | alkylphosphate | wt % | 1 | 2 | 10 | — |
| stabilizer | | | | | | |

1) Ethylene glycol: product from Hanyang Chemicals
2) Propylene glycol: product from Hanyang Chemicals
3) 4,4-Thio-bis-(3-methyl-6-t-butylphenol): 3M, USA
4) Triethanolamine: EH-3615S of ASAHI DENKA. Japan
5) 2-Mercaptobenzimidazole: MD-157 of Kukdo Chemicals
6) Molybdate: MD-10 of CVC SPECIALTY CHEMICALS, USA
7) Benzotriazole: DABCO DC-15 of Air Product, USA
8) Sodium benzoate: SBA-2 of Air Product, USA
9) Alkylphosphate: Alkylphosphate of Youngchang Chemicals

The Table 1 is a table comparing the components and contents of Examples 1 to 3 and the Comparative Example. These solutions can be properly manufactured by a person skilled in the art referring to known methods while maintaining the pH of the composition at 7.5˜8. The results of testing physical properties of Examples 1 to 3 and the Comparative Example were listed in the following Tables 2 and 3.

TABLE 2

| | | | | | Comparative |
|---|---|---|---|---|---|
| Section | Unit | Example 1 | Example 2 | Example 3 | Example 1 |
| Boiling Point | ° C. | 148 | 152 | 151 | 145 |
| Viscosity | P | 2756 | 2723 | 2719 | 2710 |
| (−40° C.) | | | | | |
| Viscosity | P | 2.5 | 2.3 | 2.2 | 2.1 |
| (100° C.) | | | | | |

The Table 2 is a table showing boiling points and viscosities of Examples 1 to 3 and the Comparative Example manufactured by referring the above Table 1. The boiling point and the viscosity in the table were tested according to the standard of KS M 2141. As a result, the boiling points and the viscosities of Examples 1 to 3, which contained the dispersion stabilizer, and the Comparative Example, which did not contain the dispersion stabilizer, were almost the same.

Further, the corrosiveness and foreign substance production numbers of the anti-vibration rubber against the engine mount solution were measured and the results thereof were listed in the following table.

TABLE 3

| | | | | | |
|---|---|---|---|---|---|
| | | | | | Compar- |
| | | Exam- | Exam- | Exam- | ative |
| Section | Unit | ple 1 | ple 2 | ple 3 | Example 1 |

| | | | |
|---|---|---|---|
| Initial | Hardness | HS | 45 |
| Value | Tensile | kgf/ | 220 |
| | Strength | cm² | |
| | Elongation | % | 610 |
| | Rate | | |

| | | | | | |
|---|---|---|---|---|---|
| Hardness Variation | HS | −5 | −2 | −3 | −7 |
| Tensile Strength | % | −6 | −3 | −5 | −10 |
| Variation | | | | | |
| Elongation Rate | % | −8 | −4 | −6 | −9 |
| Variation | | | | | |
| Foreign Substance | — | 220,000 | 40,000 | 150,000 | 250,000 |
| Production Number | | | | | |
| (Particle Size 25 μm | | | | | |
| or more/100 ml) | | | | | |

The Table 3 is a table comparing variations of hardness, tensile strength and elongation rate, and the foreign substance production number of Examples 1 to 3 and the Comparative Example.

More specifically, rubber samples made of natural rubber as a major component, corresponding to the anti-vibration rubber of the engine mount, were dipped in the engine mount solutions manufactured by referring Examples 1 to 3 and the Comparative Example at 125° C. for 1,000 hrs. The variations of hardness, tensile strength and elongation rate, and the foreign substance production number of rubber samples were then measured.

At this time, the hardness was measured with R scale according to American Society for Testing and Materials (ASTM) D785, the tensile strength and the elongation rate were measured according to ASTM D683, and cross-head speed was set to 50 mm/min

As a result, Examples 1 to 3, which contained the dispersion stabilizer, demonstrated a smaller physical property change than the Comparative Example 1, which did not contain the dispersion stabilizer. Further, there was a reduction in Examples 1 to 3 in the phenomenon of flowing out of the additives contained in the anti-vibration rubber and clumping as foreign substances. Examples 1 to 3, which were in accordance with the present invention, inhibited the aging of the rubber and flowing out and cohesion of the additives contained in the anti-vibration rubber better than Comparative Example 1.

The present invention having the constitution described above has an advantage of maintaining vibration absorbing ability even at high temperatures. This advantage is particularly due to providing the present composition with a higher boiling point than the conventional engine mount solution, particularly by including propylene glycol in the solvent. Namely, regardless of the temperature change, uniform fluidity of the engine mount solution can be secured using the present composition.

Further, by including the dispersion stabilizer in the present composition, the anti-vibration performance of the engine mount can be maintained by preventing the cohesion of the chemical additives flowed out from the anti-vibration rubber.

Further, the hydraulic engine mount solution composition according to the present invention has an advantage in that the anti-vibration and anti-corrosion effects are superior to the existing engine mount by inhibiting aging of the engine amount material such as an anti-vibration rubber, an orifice and a nozzle, and extending life of the engine mount.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A hydraulic engine mount solution composition comprising:
a mixed solution of ethylene glycol and propylene glycol as a solvent;
a dispersion stabilizer; and
a phenol-based antioxidant.

2. The hydraulic engine mount solution composition according to claim 1, which further comprises a heat stabilizer and/or a metal corrosion inhibitor.

3. The hydraulic engine mount solution composition according to claim 1, which comprises: about 65˜70 wt % of the ethylene glycol, about 25˜30 wt % of the propylene glycol, about 2˜5 wt % of the dispersion stabilizer and about 0.3˜7 wt % of the phenol-based antioxidant, based on the total weight of the composition.

4. The hydraulic engine mount solution composition according to claim 2, which comprises about 0.5˜3 wt % of the heat stabilizer and about 0.5˜5 wt % of the metal corrosion inhibitor, based on the total weight of the composition.

5. The hydraulic engine mount solution composition according to claim 1, wherein the dispersion stabilizer comprises at least one selected from the group consisting of: alkylphosphate, alkyletherphosphate and alkylaryletherphosphate.

6. The hydraulic engine mount solution composition according to claim 1, wherein the phenol-based antioxidant comprises at least one selected from the group consisting of: 2,6-di-t-butyl-p-cresole, 4,4-thio-bis-(3-methyl-6-t-butylphenol), 4,4-butadiene-bis-(3-methyl-6-t-butylphenol) and 2,2-methylene-bis-(4-methyl-6-t-butylphenol).

7. The hydraulic engine mount solution composition according to claim 2, wherein the heat stabilizer is 2-mercaptobenzimidazole.

8. The hydraulic engine mount solution composition according to claim 2, wherein the metal corrosion inhibitor comprises molybdate and benzotriazole.

9. The hydraulic engine mount solution composition according to claim 8, wherein the weight ratio of the molybdate and the benzotriazole is about 1:1˜1.5.

10. The hydraulic engine mount solution composition according to claim 1, having a pH of about 7˜9.
